(19) United States
(12) Patent Application Publication
(10) Pub. No.: US 2023/0373748 A1
(43) Pub. Date: Nov. 23, 2023

(54) ELEVATOR COMMUNICATION SYSTEM, A METHOD AND AN APPARATUS

(71) Applicant: KONE Corporation, Helsinki (FI)

(72) Inventor: Ari Kattainen, Helsinki (FI)

(73) Assignee: KONE Corporation, Helsinki (FI)

(21) Appl. No.: 18/228,226

(22) Filed: Jul. 31, 2023

Related U.S. Application Data
(63) Continuation of application No. PCT/EP2021/052326, filed on Feb. 1, 2021.

(51) Int. Cl. B66B 1/34; B66B 5/02; B66B 5/00

(52) U.S. Cl. CPC B66B 1/3461; B66B 1/3423; B66B 5/021; B66B 5/0012

(57) ABSTRACT

According to an aspect, there is provided an elevator communication system. The system comprises an elevator communication network configured to carry elevator system associated data; a plurality of elevator system nodes communicatively connected to the elevator communication network, wherein at least some of the plurality of elevator system nodes each comprises a camera associated with different landing floors, respectively, configured to provide image data about a respective landing floor area; and a controller communicatively connected to the elevator communication network and being configured to obtain image data from at least one camera during an evacuation situation; and provide, during the evacuation situation, to a node communicatively connected to the elevator communication network information for a graphical user interface comprising image data from a selected set of the cameras.

### TECHNICAL FIELD

The present application relates to the field of elevator communication systems.

### BACKGROUND

In modern elevator system, elevators can be controlled efficiently to transport passenger between floors in a building. However, sometimes it may happen, for example, in an evacuation situation when evacuating people using elevators that the evacuation personnel has no beforehand information about the situation in various landing floors and the people there.

### SUMMARY

According to a first aspect, there is provided an elevator communication system comprising an elevator communication network configured to carry elevator system associated data; a plurality of elevator system nodes communicatively connected to the elevator communication network, wherein at least some of the plurality of elevator system nodes each comprises a camera associated with different landing floors, respectively, configured to provide image data about a respective landing floor area; and a controller communicatively connected to the elevator communication network and being configured to obtain image data from at least one camera during an evacuation situation, and provide, during the evacuation situation, to a node communicatively connected to the elevator communication network information for a graphical user interface comprising image data from a selected set of the cameras.

In an implementation form of the first aspect, at least some of the plurality of elevator system nodes each comprises audio means arranged at different landing floors, respectively, enabling two-way voice communication.

In an implementation form of the first aspect, each landing floor comprises at least one node comprising a camera and at least one node comprising audio means.

In an implementation form of the first aspect, each landing floor comprising at least one node comprising a camera comprises also at least one node comprising audio means.

In an implementation form of the first aspect, the graphical user interface comprises a user interface element enabling a simultaneous audio connection to audio means of all landing floors, wherein the controller is configured to receive information indicating a selection of the user interface element; and establish a one-way voice communication towards the audio means of each landing floor from the node.

In an implementation form of the first aspect, the controller is configured to obtain a landing call from at least one landing floor, wherein the graphical user interface provided to the node comprises an expanded image frame for image data of a camera of a landing floor from which a landing call exists and a miniature image frame for image data of a camera of a landing floor from which no landing call exists; receive information indicating a selection of an expanded image frame; and establish a two-way voice communication between audio means of a landing floor associated with the image data of the expanded image frame and the node.

In an implementation form of the first aspect, the graphical user interface comprises a separate miniature image frame for image data of each camera and wherein the controller is configured to receive information indicating a selection of a miniature image frame; provide an expanded image frame for the selected miniature frame to the node; and establish a two-way voice communication between audio means of a landing floor associated with the image data of the expanded image frame and the node.

In an implementation form of the first aspect, the graphical user interface comprises a separate miniature image frame for image data of each camera.

In an implementation form of the first aspect, the selected set of cameras comprises all cameras associated with the landing floors.

In an implementation form of the first aspect, the controller is configured to obtain a landing call from at least one landing floor; and wherein the selected set comprises cameras associated with the landing floors from which landing calls exist.

In an implementation form of the first aspect, the controller is configured to obtain a landing call from at least one landing floor; and wherein the graphical user interface provided to the node comprises an expanded image frame for image data of a camera of a landing floor from which a landing call exists and a miniature image frame for image data of a camera of a landing floor from which no landing call exists.

In an implementation form of the first aspect, the controller is configured to provide the graphical user interface for display by the node.

In an implementation form of the first aspect, the node is configured to provide the graphical user interface for display by a node communicatively connected to the elevator communication network.

In an implementation form of the first aspect, the node comprises a node internal to the elevator communication system.

In an implementation form of the first aspect, the node comprises a display arranged in an elevator car.

In an implementation form of the first aspect, the node comprises a remote node external to the elevator communication system.

In an implementation form of the first aspect, the elevator communication network comprises at least one point-to-point ethernet network.

In an implementation form of the first aspect, the elevator communication network comprises at least one multi-drop ethernet segment.

According to a second aspect, there is provided a method comprising: obtaining, by a controller connected to an elevator communication network, image data from at least one camera of landing floors during an evacuation situation, the at least one camera being communicatively connected to the elevator communication network, and provide, by the controller, during the evacuation situation to a node communicatively connected to the elevator communication network information for a graphical user interface comprising image data from a selected set of the cameras.

In an implementation form of the second aspect, at least some of the plurality of elevator system nodes each comprises audio means arranged at different landing floors, respectively, enabling two-way voice communication.

In an implementation form of the second aspect, each landing floor comprises at least one node comprising a camera and at least one node comprising audio means.

In an implementation form of the second aspect, each landing floor comprising at least one node comprising a camera comprises also at least one node comprising audio means.

In an implementation form of the second aspect, the graphical user interface comprises a user interface element enabling a simultaneous audio connection to audio means of all landing floors, wherein the method further comprises: receiving, by the controller, information indicating a selection of the user interface element; and establishing, by the controller, a one-way voice communication towards the audio means of each landing floor from the node.

In an implementation form of the second aspect, the method further comprises: obtaining, by the controller, a landing call from at least one landing floor, wherein the graphical user interface provided to the node comprises an expanded image frame for image data of a camera of a landing floor from which a landing call exists and a miniature image frame for image data of a camera of a landing floor from which no landing call exists; receiving, by the controller, information indicating a selection of an expanded image frame; and establishing, by the controller, a two-way voice communication between audio means of a landing floor associated with the image data of the expanded image frame and the node.

In an implementation form of the second aspect, the graphical user interface comprises a separate miniature image frame for image data of each camera and wherein the method further comprises: receiving, by the controller, information indicating a selection of a miniature image frame; providing, by the controller, an expanded image frame for the selected miniature frame to the node; and establishing, by the controller, a two-way voice communication between audio means of a landing floor associated with the image data of the expanded image frame and the node.

In an implementation form of the second aspect, the graphical user interface comprises a separate miniature image frame for image data of each camera.

In an implementation form of the second aspect, the selected set of cameras comprises all cameras associated with the landing floors.

In an implementation form of the second aspect, the method further comprises obtaining, by the controller, a landing call from at least one landing floor; and wherein the selected set comprises cameras associated with the landing floors from which landing calls exist.

In an implementation form of the second aspect, the method further comprises obtaining, by the controller, a landing call from at least one landing floor; and wherein the graphical user interface provided to the node comprises an expanded image frame for image data of a camera of a landing floor from which a landing call exists and a miniature image frame for image data of a camera of a landing floor from which no landing call exists.

In an implementation form of the second aspect, the method further comprises providing, by the controller, the graphical user interface for display by the node.

In an implementation form of the second aspect, the node is configured to provide the graphical user interface for display by a node communicatively connected to the elevator communication network.

In an implementation form of the second aspect, the node comprises a node internal to the elevator communication system.

In an implementation form of the second aspect, the node comprises a display arranged in an elevator car.

In an implementation form of the second aspect, the node comprises a remote node external to the elevator communication system.

In an implementation form of the second aspect, the elevator communication network comprises at least one point-to-point ethernet network.

In an implementation form of the second aspect, the elevator communication network comprises at least one multi-drop ethernet segment.

According to a third aspect, there is provided a computer program comprising program code, which when executed by at least one processor, causes the at least one processor to perform the method of the second aspect.

According to a fourth aspect, there is provided a computer readable medium comprising program code, which when executed by at least one processor, causes the at least one processor to perform the method of the second aspect.

According to a fifth aspect, there is provided an elevator system comprising an elevator communication system of the first aspect.

According to a sixth aspect, there is provided an apparatus connected to an elevator communication network. The apparatus comprises means for obtaining image data from at least one camera of landing floors during an evacuation situation, the at least one camera being communicatively connected to the elevator communication network, and means for providing during the evacuation situation to a node communicatively connected to the elevator communication network information for a graphical user interface comprising image data from a selected set of the cameras.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator communication system according to an example embodiment.

FIG. 1B illustrates an elevator communication system according to another example embodiment.

FIG. 1C illustrates an elevator communication system according to another example embodiment.

FIG. 1D illustrates an elevator communication system according to another example embodiment.

FIG. 2 illustrates an apparatus associated with an elevator communication system according to an embodiment.

FIG. 3 illustrates a method according to an example embodiment.

FIG. 4A illustrates a simplified graphical user interface provided by a controller according to an example embodiment.

FIG. 4B illustrates a simplified graphical user interface provided by a controller according to another example embodiment.

FIG. 4C illustrates a simplified graphical user interface provided by a controller according to another example embodiment.

### DETAILED DESCRIPTION

The following description illustrates an elevator communication system that comprises an elevator communication network configured to carry elevator system associated data, a plurality of elevator system nodes communicatively connected to the elevator communication network, wherein at least some of the plurality of elevator system nodes each comprises a camera associated with different landing floors, respectively, configured to provide image data about a respective landing floor area and audio means arranged at each landing floor enabling two-way voice communication, and a controller communicatively connected to the elevator communication network and being configured to obtain image data from at least one camera during an evacuation situation, and provide, during the evacuation situation, to a node communicatively connected to the elevator communication network information for a graphical user interface comprising image data from a selected set of the cameras. The illustrated solution may enable, for example, a solution in which in an evacuation situation image data relating to one or more landing floors may be obtained and a node arranged, for example, in an elevator car or as a remote node external to the elevator communication system is provided with image data relating to at one landing floor. The illustrated solution may also enable establishment of a one-way or a two-way voice connection between a selected landing floor and the node.

In an example embodiment, the various embodiments discussed below may be used in an elevator system comprising an elevator that is suitable and may be used for transferring passengers between landing floors of a building in response to service requests. In another example embodiment, the various embodiments discussed below may be used in an elevator system comprising an elevator that is suitable and may be used for automated transferring of passengers between landings in response to service requests.

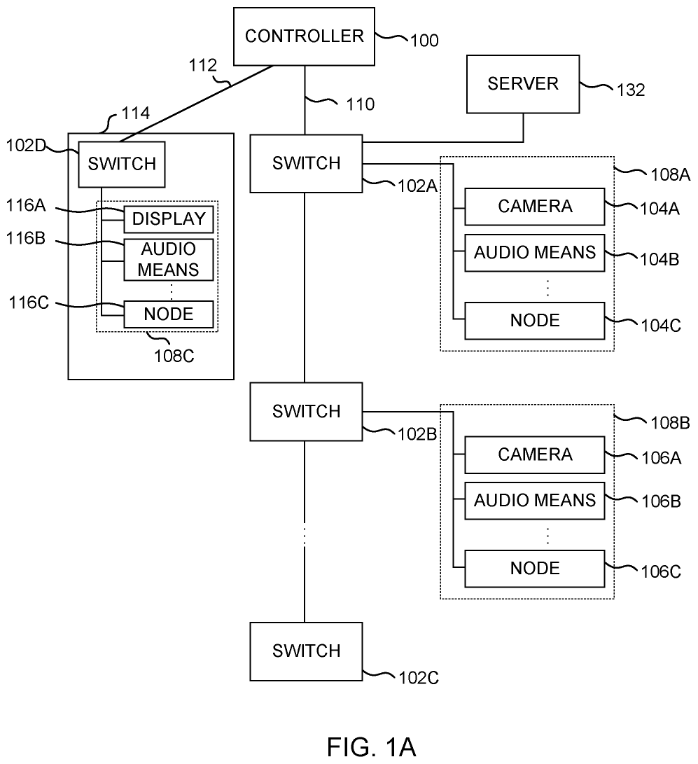

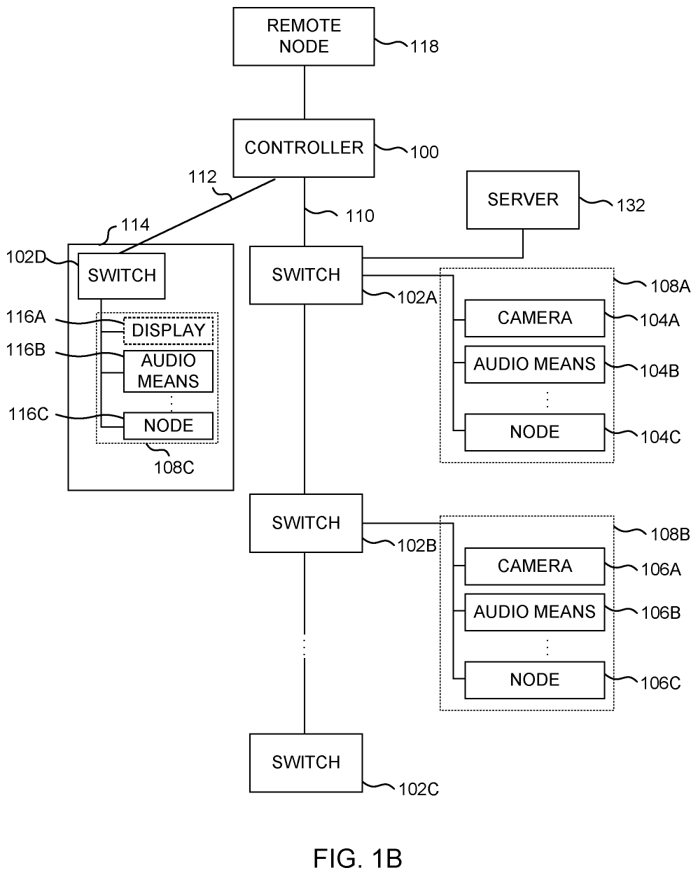

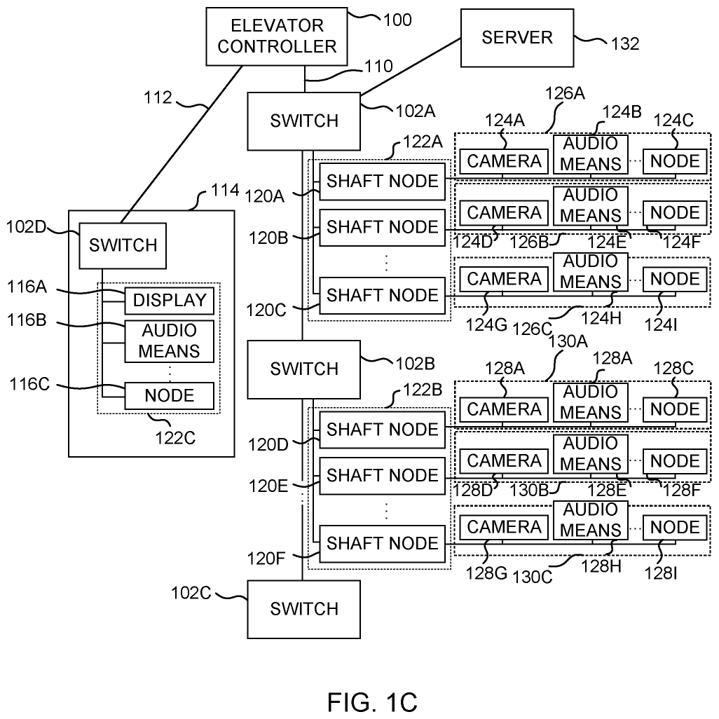

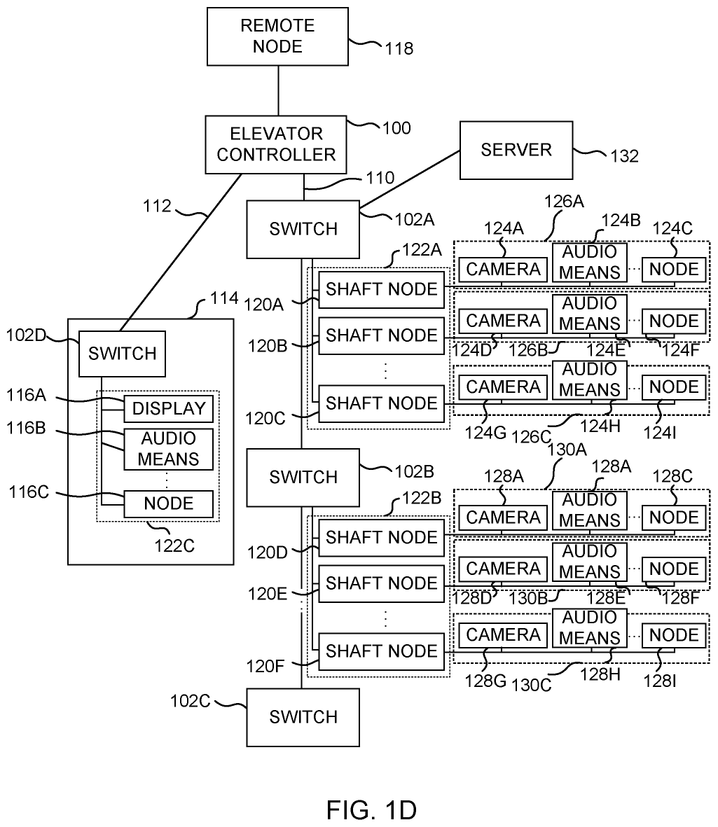

FIG. 1A illustrates an elevator communication system according to an example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet bus may be, for example, a 100BASE-TX or 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 102A, 102B, 102C comprising a first port connected to the respective multi-drop ethernet bus segments 108A, 108B and a second port connected to the point-to-point ethernet bus 110. Thus, by using the connecting units 102A, 102B, 102C, one or more multi-drop ethernet bus segments 108A, 108B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C may be connected to the connecting unit 102D via a multi-drop ethernet bus segment 108C, thus constituting an elevator car segment 108C. In an example embodiment, the point-to-point-ethernet bus 112 may be located in the travelling cable of the elevator car 114.

The elevator communication system may further comprise one or more multi-drop ethernet bus segments 108A, 108B (for example, in the form of 10BASE-T1S) reachable by the elevator controller 100, and a plurality of elevator system nodes 104A, 104B, 104C, 106A, 106B, 106C coupled to the multi-drop ethernet bus segments 108A, 108B and configured to communicate via the multi-drop ethernet bus 108A, 108B. The elevator controller 100 is reachable by the elevator system nodes 104A, 104B, 104C, 106A, 106B, 106C via the multi-drop ethernet bus segments 108A, 108B. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 104A, 104B, 104C, 106A, 106B, 106C may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 104A, 104B, 104C, 106A, 106B, 106C may comprise shaft nodes, and a plurality of shaft nodes may form a shaft segment, for example, the multi-drop ethernet bus segment 108A, 108B.

At least some of the plurality of elevator system nodes 104A-104C, 106A-106C, 116A-116C each may comprise a camera 104A, 106A associated with different landing floors, respectively, configured to provide image data about a respective landing floor area. The image data may comprise still image data or video data. The camera 104A, 106A may be integrated into a respective landing floor display which is located, for example, above the landing doors. The camera 104A, 106A may also be integrated into an elevator call device arranged at the landing floor. In an example embodiment, each landing floor may comprise at least one node comprising a camera and at least one node comprising audio means. In another example embodiment, each landing floor comprising at least one node comprising a camera comprises also at least one node comprising audio means.

The plurality of elevator system nodes 104A-104C, 106A-106C, 116A-116C may also comprise a display 116A arranged in the elevator car 114. For example, during a normal elevator use, the display 116A may be used as an infotainment device for passengers. In an evacuation situation, the display 116A may be configured to display data provided by at least one of the cameras 104A, 106A. The elevator car 114 may also comprise at least one speaker and microphone.

The elevator communication system may also comprise an apparatus, for example, a server 132 communicatively connected to the controller 100. In an example embodiment, the server may receive from the controller 100 image data from a selected set of the at least one camera 104A, 106A and provide a graphical user interface to be displayed by a display, for example, a display 116A, based on the received image data.

In an example embodiment, the plurality of elevator system nodes 104A-104C, 106A-106C, 116A-116C may also comprise audio means 104B, 106B, 116B. The audio means 104B, 106B may be integrated, for example, into a respective landing floor display which is located, for example, above the landing doors. The audio means 104B, 106B may also be integrated into an elevator call device arranged at the landing floor. In the elevator car 114, the audio means 116B may be integrated, for example, in a car operating panel.

In an example embodiment, at least some of the plurality of elevator system nodes 104A-104C, 106A-106C each comprises audio means 104B, 106B arranged at different landing floors, respectively, enabling two-way voice communication.

FIG. 1B illustrates an elevator communication system according to another example embodiment. The system illustrated in FIG. 1B differs from the system illustrated in FIG. 1A in that a remote node 118 may be communicatively connected to the controller 100. The remote node 118 may be an external node to the elevator communication system, and the controller 100 may be used for providing a connection to the remote node 118. In an evacuation situation, the remote node 118 may be configured to display on a display data provided by at least one of the cameras 104A, 106A.

FIG. 1C illustrates an elevator communication system according to another example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus and/or at least one multi-drop ethernet segment. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 102A, 102B, 102C comprising a first port connected to the respective multi-drop ethernet bus segments 122A, 122B and a second port connected to the point-to-point ethernet bus 110. Thus, by using the connecting units 102A, 102B, 102C, one or more multi-drop ethernet bus segments 122A, 122B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C may be connected to the connecting unit 102 via a multi-drop ethernet bus segment 122C, thus constituting an elevator car segment 122C. In an example embodiment, the point-to-point-ethernet bus 112 is located in the travelling cable of the elevator car 114.

The elevator communication system may further comprise one or more multi-drop ethernet bus segments 122A, 122B, 126A-126C, 130A-130C (for example, in the form of 10BASE-T1S) reachable by the controller 100, and a plurality of elevator system nodes 120A-120F, 124A-124I, 128A-128I coupled to the multi-drop ethernet bus segments 122A, 122B, 126A-126C, 130A-130C and configured to communicate via the multi-drop ethernet bus segments 122A, 122B, 126A-126C, 130A-130C. The controller 100 is reachable by the elevator system nodes 120A-120F, 124A-124I, 128A-128I via the multi-drop ethernet bus segments 122A, 122B, 126A-126C, 130A-130C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 116A-116C, 124A-124C, 130A-130I may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 120A-120F may comprise shaft nodes, and a plurality of shaft nodes may form a shaft segment, for example, the multi-drop ethernet bus segment 122A, 122B.

At least some of the plurality of elevator system nodes 116A-116C, 124A-124I, 128A-128I each may comprise a camera 124A, 124D, 124G, 128A, 128D, 128G associated with different landing floors configured to provide image data about a respective landing floor area. The camera 124A, 124D, 124G, 128A, 128D, 128G may be integrated into a respective landing floor display which is located, for example, above the landing doors. The camera 124A, 124D, 124G, 128A, 128D, 128G may also be integrated into an elevator call device arranged at the landing floor. The plurality of elevator system nodes 116A-116C, 124A-124I, 128A-128I may also comprise a display 116A arranged in the elevator car 114. For example, during a normal elevator use, the display 116A may be used as an infotainment device for passengers. In an evacuation situation, the display 116A may be configured to display data provided by at least one of the cameras 124A, 124D, 124G, 128A, 128D, 128G. The elevator car 114 may also comprise at least one speaker and microphone.

In an example embodiment, each landing floor may comprise at least one node comprising a camera and at least one node comprising audio means. In another example embodiment, each landing floor comprising at least one node comprising a camera comprises also at least one node comprising audio means.

The elevator communication system may also comprise an apparatus, for example, a server 132 communicatively connected to the controller 100. In an example embodiment, the server may receive from the controller 100 image data from a selected set of the at least one camera 104A, 106A and provide a graphical user interface to be displayed by a display, for example, a display 116A, based on the received image data.

In an example embodiment, the plurality of elevator system nodes 104A-104C, 106A-106C, 116A-116C may also comprise audio means 104B, 106B, 116B. The audio means 104B, 106B may be integrated, for example, into a respective landing floor display which is located, for example, above the landing doors. The audio means 104B, 106B may also be integrated into an elevator call device arranged at the landing floor. In the elevator car 114, the audio means 116B may be integrated, for example, in a car operating panel.

In an example embodiment, at least some of the plurality of elevator system nodes 124A-124I, 128A-128I each comprises audio means 124B, 124E, 124H, 128B, 128E, 128H arranged at different landing floors, respectively, enabling two-way voice communication.

By implementing communication within the elevator communication system using at least one point-to-point ethernet bus and at least one multi-drop ethernet bus segment, various segments can be formed within the elevator communication system. For example, the elevator system nodes 124A-124C may form a first landing segment 126A, the elevator system nodes 124D-124F may form a second landing segment 126B, the elevator system nodes 124G-124I may form a third landing segment 126C, the shaft nodes 120A-120C may form a first shaft segment 122A, the shaft nodes 120D-120F may form a second shaft segment 122B, and the elevator car nodes 116A-116C may form an elevator car segment 122C. Each of the segments 122A-122C, 126A-126C may be implemented using separate multi-drop ethernet buses.

As illustrated in FIG. 10, the shaft nodes 120A-120F interconnect the shaft segments 122A, 122B to which the shaft nodes 124A-124I, 128A-128I are connected to and the landing segments 126A-126C. In other words, the shaft nodes 120A-120C may comprise or may act as a switch to the landing segments 126A-126C, 130A-130C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc. may be connected.

FIG. 1D illustrates an elevator communication system according to another example embodiment. The system illustrated in FIG. 1D differs from the system illustrated in FIG. 1C in that a remote node 118 may be communicatively connected to the controller 100. The remote node 118 may be an external node to the elevator communication system, and the controller 100 may be used for providing a connection to the remote node 118. In an evacuation situation, the remote node 118 may be configured to display on a display data provided by at least one of the cameras 124A, 124D, 124G, 128A, 128D, 128G.

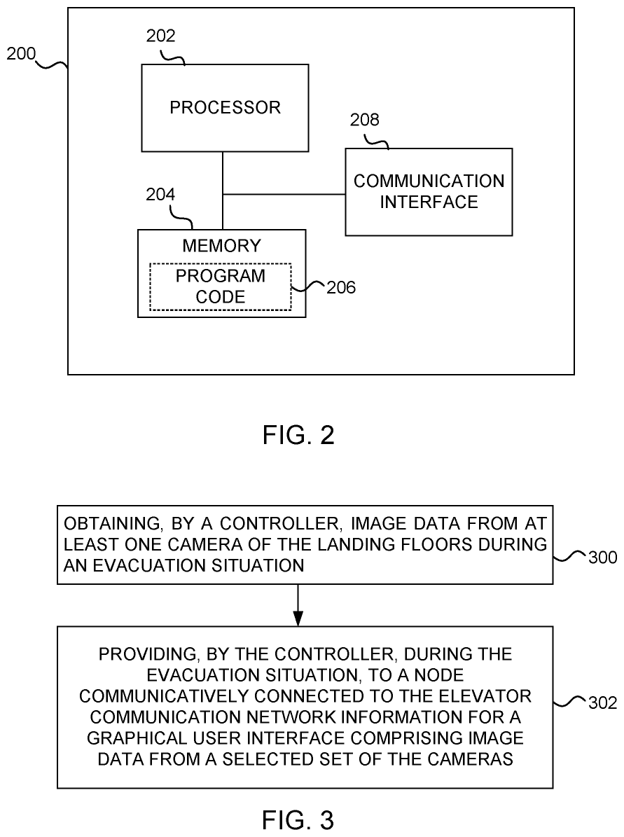

FIG. 2 illustrates an apparatus 200 associated with an elevator communication system according to an embodiment. The apparatus 200 may comprise at least one processor 202. The apparatus 200 may further comprise at least one memory 204. The memory 204 may comprise program code 206 which, when executed by the processor 202 causes the apparatus 200 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 200 is illustrated as a single device it is appreciated that, wherever applicable, functions of the apparatus 200 may be distributed to a plurality of devices.

Example embodiments may be implemented in software, hardware, application logic or a combination of software, hardware and application logic. The example embodiments can store information relating to various methods described herein. This information can be stored in one or more memories 204, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 202 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 204 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 200 may comprise a communication interface 208 configured to enable the apparatus 200 to transmit and/or receive information, to/from other apparatuses. The apparatus 200 comprises means for performing at least one method described herein. In one example, the means may comprise the at least one processor 202, the at least one memory 204 including program code 206 configured to, when executed by the at least one processor 202, cause the apparatus 200 to perform the method.

FIG. 3 illustrates a method according to an example embodiment. The method may be performed, for example, in an elevator communication system illustrated in any of FIGS. 1A-1D.

At 300, image data from at least one camera of the landing floors during an evacuation situation is obtained by the controller 100. The controller 100 may be, for example, an elevator controller being communicatively connected to an elevator communication network.

At 302 information for a graphical user interface comprising image data from a selected set of the cameras to be displayed by the node 116A, 118 is provided by the controller 100 to the node 116A, 118, 132 communicatively connected to the elevator communication network. As illustrated in FIGS. 1A-1D, the node 116A, 118 may be an internal node of the elevator communication system or an external node to the elevator communication system. The term “image data” may refer to separate still images that may be played back sequentially or to video data. Further, depending on the embodiment, the actual graphical user interface may be provided by the controller 100 or the server 132.

In an example embodiment, the selected set of cameras comprises all cameras of the landing floors. In other words, the graphical user interface may comprise a separate view about each landing floor. In another example embodiment, the controller 100 may be configured to obtain a landing call from at least one landing floor, and the selected set of the cameras comprises cameras associated with the landing floors from which landing calls exist. In other words, the graphical user interface may comprise a separate view only about each landing floor from which a landing call exists.

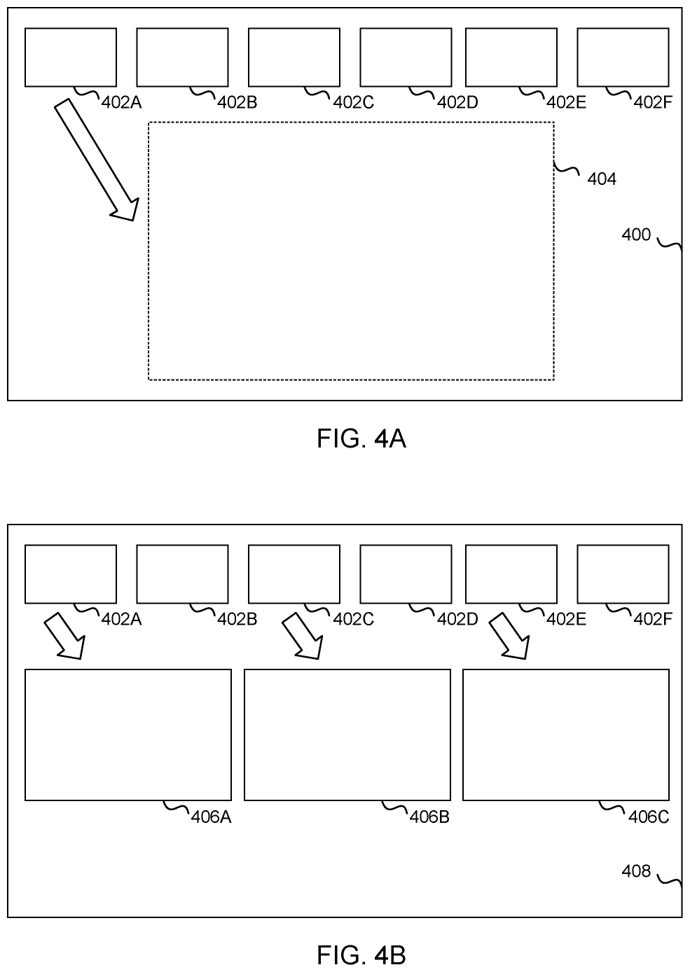

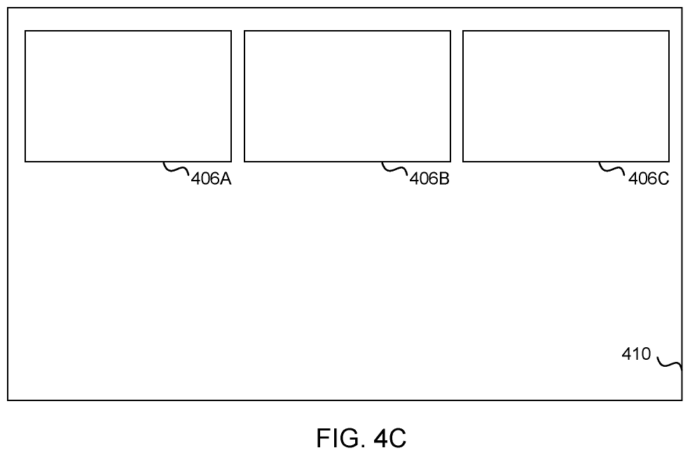

FIG. 4A illustrates a simplified graphical user interface view 400 provided by the controller 100 or the server 132 according to an example embodiment. The view 400 may comprise a miniature image frame 402A-402F for image data of each camera associated with the landing floors. The term “miniature image frame” may refer to a small preview type window showing image data from one camera. In other words, each miniature image frame 402A-402F may be configured to display image data from a different landing floor. The view 400 may be provided, for example, by the display 116A arranged in the elevator car 114 or by a display associated with the remote node 118. In another example embodiment, the display may be arranged at any appropriate location in a building.

The controller 100 may be configured to receive information indicating a selection of a miniature image frame and provide an expanded image frame 404 for the selected miniature frame to the node 116A, 118. The term “expanded image frame” may refer to a larger window that shows the image data in a larger form compared to the miniature image frame. A user standing in the elevator car 114 may select one of the miniature image frames 402A-402F, for example, using a touch-sensitive display 116A arranged in the elevator car 114. Or, a user operating the remote node 118 may select the miniature image frame from the view 400 using a pointing device, for example, a mouse or by selecting the miniature image frame from a touch-sensitive display.

The controller 100 may also be configured to establish a two-way voice communication between audio means 104B, 106B, 124B, 124E, 124H, 128A, 128E, 128H of a landing floor associated with the image data of the expanded image frame and the node 116A, 118. The audio means 104B, 106B, 124B, 124E, 124H, 128A, 128E, 128H may comprise, for example, at least one speaker and microphone. This means that passengers waiting at the landing floor are able to hear the person speaking in the elevator car 114 or at the remote node 118, and the person in the elevator car 114 is able hear what the passengers speak at the landing floor.

FIG. 4B illustrates a simplified graphical user interface provided by the controller 100 according to another example embodiment. The view 408 may comprise a miniature image frame 402A-402F for image data of each camera of the landing floors. The term “miniature image frame” may refer to a small preview type window showing image data from one camera. In other words, each miniature image frame 402A-402F is configured to display image data from a different landing floor. The view 408 may be provided, for example, by the display 116A arranged in the elevator car 114 or by a display associated with the remote node 118.

The controller 100 may be configured to obtain a landing call from at least one landing floor, and the view 404 may comprise expanded image frames 406A, 406B, 406C for image data of a camera of a landing floor from which a landing call exists and a miniature image frame 402B, 402D, 402F for image data of a camera of a landing floor from which no landing call exists. The term “expanded image frame” may refer to a larger window that shows the image data in a larger form compared to the miniature image frame.

The controller 100 may be configured to receive information indicating a selection of an expanded image frame 406A, 406B, 406C. A user standing in the elevator car 114 may select one of the expanded image frames 406A-406C, for example, using a touch-sensitive display 116A arranged in the elevator car 114. Or, a user operating the remote node 118 may select one of the expanded image frames 406A-4060 using a pointing device, for example, a mouse or by selecting the expanded image frame from a touch-sensitive display. In response to the selection, the controller 100 may be configured to establish a two-way voice communication between audio means 104B, 106B, 124B, 124E, 124H, 128A, 128E, 128H of a landing floor associated with the image data of the selected expanded image frame and the node 116A, 118. The audio means 104B, 106B, 124B, 124E, 124H, 128A, 128E, 128H may comprise, for example, at least one speaker and microphone. This means that passengers waiting at the landing floor are able to hear the person speaking in the elevator car 114 or at the remote node 118, and the person in the elevator car 114 is able hear what the passengers speak at the landing floor.

FIG. 4C illustrates a simplified graphical user interface provided by the controller 100 according to another example embodiment.

The controller 100 may be configured to obtain a landing call from at least one landing floor, and the view 410 may comprise an expanded image frame 406A, 406B, 406C for image data of a camera of a landing floor from which a landing call exists. The term “expanded image frame” may refer to a larger window that shows the image data in a larger form compared to the miniature image frame. The controller 100 may be configured to receive information indicating a selection of an expanded image frame 406A, 406B, 406C. A user standing in the elevator car 114 may select one of the expanded image frames 406A-406C, for example, using a touch-sensitive display 116A arranged in the elevator car 114. Or, a user operating the remote node 118 may select the one of the expanded image frames 406A-4060 using a pointing device, for example, a mouse or by selecting the expanded image frame from a touch-sensitive display. In response to the selection, the controller 100 may be configured to establish a two-way voice communication between audio means 104B, 106B, 124B, 124E, 124H, 128A, 128E, 128H of a landing floor associated with the image data of the selected expanded image frame and the node 116A, 118.

The audio means 104B, 106B, 124B, 124E, 124H, 128A, 128E, 128H may comprise, for example, at least one speaker and microphone. This means that passengers waiting at the landing floor are able to hear the person speaking in the elevator car 114 or at the remote node 118, and the person in the elevator car 114 is able to hear what the passengers speak at the landing floor.

In any of the embodiments illustrated in FIGS. 4A-4C, the view 400, 408, 410 may comprise a user interface element enabling a simultaneous audio connection to audio means of all landing floors, i.e. enabling a broadcast functionality. The controller 100 may be configured to receive information indicating a selection of the user interface element and establish a one-way voice communication towards the audio means of each landing floor from the node 116A, 118. This enables a situation in which a user standing in the elevator car 114 or a user operating the remote node 118 may give announcements simultaneously to all landing floors.

At least some of the above discussed example embodiments may enable transmission of any device data seamlessly between elevator system devices and any other device or system. Further, a common protocol stack may be used for all communication. Further, at least some of the above discussed example embodiments may enable a solution in which a person in an elevator car or at a remote operating point is able to see image data from a landing floor or landing floors in an evacuation situation and establish a two-way voice communication with a desired landing floor. Thus, the person in the elevator car or at the remote operating point is able, for example, to provide instructions or notifications to the landing floor(s) during the evacuation situation.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator communication system, comprising:
an elevator communication network configured to carry elevator system associated data;
a plurality of elevator system nodes communicatively connected to the elevator communication network, wherein at least some of the plurality of elevator system nodes each comprises a camera associated with different landing floors, respectively, configured to provide image data about a respective landing floor area; and
a controller communicatively connected to the elevator communication network and being configured to:
obtain image data from at least one camera during an evacuation situation; and
provide, during the evacuation situation, to a node communicatively connected to the elevator communication network information for a graphical user interface comprising image data from a selected set of the cameras.

2. The elevator communication system of claim 1, wherein at least some of the plurality of elevator system nodes each comprises audio means arranged at different landing floors, respectively, enabling two-way voice communication.

3. The elevator communication system of claim 1, wherein each landing floor comprises at least one node comprising a camera and at least one node comprising audio means.

4. The elevator communication system of claim 1, wherein each landing floor comprises:
at least one node comprising a camera; and
at least one node comprising audio means.

5. The elevator communication system of claim 2, wherein the graphical user interface comprises a user interface element enabling a simultaneous audio connection to audio means of all landing floors, wherein the controller is configured to:
receive information indicating a selection of the user interface element; and
establish a one-way voice communication towards the audio means of each landing floor from the node.

6. The elevator communication system of claim 2, wherein the controller is configured to:
obtain a landing call from at least one landing floor, wherein the graphical user interface provided to the node comprises an expanded image frame for image data of a camera of a landing floor from which a landing call exists and a miniature image frame for image data of a camera of a landing floor from which no landing call exists;
receive information indicating a selection of an expanded image frame; and
establish a two-way voice communication between the audio means of a landing floor associated with the image data of the expanded image frame and the node.

7. The elevator communication system of claim 2, wherein the graphical user interface comprises a separate miniature image frame for image data of each cameral and wherein the controller is configured to:
receive information indicating a selection of a miniature image frame;
provide an expanded image frame for the selected miniature frame to the node; and
establish a two-way voice communication between the audio means of a landing floor associated with the image data of the expanded image frame and the node.

8. The elevator communication system of claim 1, wherein the graphical user interface comprises a separate miniature image frame for image data of each camera.

9. The elevator communication system of claim 1, wherein the selected set of cameras comprises all cameras associated with the landing floors.

10. The elevator communication system of claim 1, wherein the controller is configured to obtain a landing call from at least one landing floor,
wherein the selected set comprises cameras associated with the landing floors from which landing calls exist.

11. The elevator communication system of claim 1, wherein the controller is configured to obtain a landing call from at least one landing floor,
wherein the graphical user interface provided to the node comprises an expanded image frame for image data of a camera of a landing floor from which a landing call exists and a miniature image frame for image data of a camera of a landing floor from which no landing call exists.

12. The elevator communication system of claim 1, wherein the controller is configured to provide the graphical user interface for display by the node.

13. The elevator communication system of claim 1, wherein the node is configured to provide the graphical user interface for display by a node communicatively connected to the elevator communication network.

14. The elevator communication system of claim 1, wherein the node comprises a node internal to the elevator communication system.

15. The elevator communication system of claim 14, wherein the node comprises a display arranged in an elevator car.

16. The elevator communication system of claim 1, wherein the node comprises a remote node external to the elevator communication system.

17. The elevator communication system of claim 1, wherein the elevator communication network comprises at least one point-to-point ethernet network.

18. The elevator communication system of claim 1, wherein the elevator communication network comprises at least one multi-drop ethernet segment.

19. A method comprising:
obtaining, by a controller connected to an elevator communication network, image data from at least one camera of landing floors during an evacuation situation, the at least one camera being communicatively connected to the elevator communication network; and
provide, by the controller, during the evacuation situation to a node communicatively connected to the elevator communication network information for a graphical user interface comprising image data from a selected set of the cameras.

20. The method of claim 19, wherein at least some of the plurality of elevator system nodes each comprises audio means arranged at different landing floors, respectively, enabling two-way voice communication.

21. The method of claim 19, wherein each landing floor comprises at least one node comprising a camera and at least one node comprising audio means.

22. The method of claim 19, wherein each landing floor comprises:
at least one node comprising a camera; and
at least one node comprising audio means.

23. The method of claim 20, wherein the graphical user interface comprises a user interface element enabling a simultaneous audio connection to audio means of all landing floors, wherein the method further comprises:
receiving, by the controller, information indicating a selection of the user interface element; and
establishing, by the controller, a one-way voice communication towards the audio means of each landing floor from the node.

24. The method of claim 20, further comprising:
obtaining, by the controller, a landing call from at least one landing floor, wherein the graphical user interface provided to the node comprises an expanded image frame for image data of a camera of a landing floor from which a landing call exists and a miniature image frame for image data of a camera of a landing floor from which no landing call exists;
receiving, by the controller, information indicating a selection of an expanded image frame; and
establishing, by the controller, a two-way voice communication between the audio means of a landing floor associated with the image data of the expanded image frame and the node.

25. The method of claim 20, wherein the graphical user interface comprises a separate miniature image frame for image data of each camera and wherein the method further comprises:
receiving, by the controller, information indicating a selection of a miniature image frame;
providing, by the controller, an expanded image frame for the selected miniature frame to the node; and
establishing, by the controller, a two-way voice communication between the audio means of a landing floor associated with the image data of the expanded image frame and the node.

26. The method of claim 19, wherein the graphical user interface comprises a separate miniature image frame for image data of each camera.

27. The method of claim 19, wherein the selected set of cameras comprises all cameras associated with the landing floors.

28. The method of claim 19, further comprising obtaining, by the controller, a landing call from at least one landing floor,
wherein the selected set comprises cameras associated with the landing floors from which landing calls exist.

29. The method of claim 19, further comprising obtaining, by the controller, a landing call from at least one landing floor,
wherein the graphical user interface provided to the node comprises an expanded image frame for image data of a camera of a landing floor from which a landing call exists and a miniature image frame for image data of a camera of a landing floor from which no landing call exists.

30. The method of claim 19, further comprising providing, by the controller, the graphical user interface for display by the node.

31. The method of claim 19, wherein the node is configured to provide the graphical user interface for display by a node communicatively connected to the elevator communication network.

32. The method of claim 19, wherein the node comprises a node internal to the elevator communication system.

33. The method of claim 32, wherein the node comprises a display (116A) arranged in an elevator car.

34. The method of claim 19, wherein the node comprises a remote node external to the elevator communication system.

35. The method system of claim 19, wherein the elevator communication network comprises at least one point-to-point ethernet network.

36. The method of claim 19, wherein the elevator communication network comprises at least one multi-drop ethernet segment.

37. A computer program comprising program code, which when executed by at least one processor, causes the at least one processor to perform the method of claim 19.

38. A computer readable medium comprising program code, which when executed by at least one processor, causes the at least one processor to perform the method of claim 19.

39. An elevator system comprising the elevator communication system of claim 1.

40. An apparatus connected to an elevator communication network, the apparatus comprising:
means for obtaining image data from at least one camera of landing floors during an evacuation situation, the at least one camera being communicatively connected to the elevator communication network; and
means for providing during the evacuation situation to a node communicatively connected to the elevator communication network information for a graphical user interface comprising image data from a selected set of the cameras.
